(19) United States
(12) Patent Application Publication
(10) Pub. No.: US 2011/0198420 A1
(43) Pub. Date: Aug. 18, 2011

(54) Irrigation water bubbler

(75) Inventors: Jerry D. Lawyer, Clermont, FL (US); Donald E. Smith, Winter Springs, FL (US)

(73) Assignee: SENNINGER IRRIGATION INC.

(21) Appl. No.: 12/658,309

(22) Filed: Feb. 12, 2010

(51) Int. Cl. B05B 1/00

(52) U.S. Cl. 239/589

(57) ABSTRACT

The present invention is directed towards a water bubbler sprinkler head for a drop hose to produce bubbling water to reduce the destructive force of the water landing on the surrounding land.

The present invention relates to irrigation systems and especially to a water bubbler sprinkler head for an irrigation sprinkler system.

### BACKGROUND OF THE INVENTION

The present water bubbler sprinkler head is especially adapted for use in mechanically moved irrigation systems which are commonly used throughout the United States for irrigating agricultural lands. Generally, wheeled line irrigation systems include a plurality of wheeled towers supporting a linear water conduit in a manner that the wheeled towers and water conduit can be moved through an agricultural field for changing the position of irrigation sprinklers coupled to the water conduit. One end of the water conduit is coupled to a water main or well and sprinkler heads are mounted in spaced alignment along the water conduit between the wheeled towers. The current practice in these irrigation systems is to connect the drop hoses from the water main to the field below with the ends thereof having sprinkler heads attached thereto for distributing the irrigation water adjacent the crops.

A LEPA irrigation system (Low Energy Precision Application) is used in these systems to reduce the destructive forces of the water in order to prevent damage and erosion to the furrow and adjacent crops. LEPA irrigation products currently commonly bounce the water spray off different surfaces until the water is directed towards the ground. The water directed towards the ground in this manner has less energy but is still sprayed towards the ground and contains enough energy to erode furrows, wash out seeds and compact the soil.

The present invention is directed towards a water bubbler sprinkler head for a drop hose to produce bubbling water to reduce the destructive force of the water landing on the surrounding land. Prior art sprinklers that utilize bubbler devices may be seen in U.S. Pat. No. 4,676,438 for a furrow irrigation bubbler device and spray head conversion assembly utilized therewith. A bubbler attachment allows for the conversion of a spray head to a furrow bubbler in the drop tube of an irrigation system. The Pescetto U.S. Pat. No. 4,131,234 teaches an adjustable bubbler sprinkler head while the von Lutzow U.S. Pat. No. 4,159,805 teaches a bubbler type sprinkler head. U.S. Pat. No. 4,477,026 to Lockwood is for a bubbler head structure for irrigation systems and has a water passageway and an air passageway Air is drawn through the air passageway and mixed with the water in a mixing chamber.

The present bubbler sprinkler head eliminates the destructive energy from sprayed irrigating water by mixing the water with air bubbles prior to the water hitting the ground in a drop line of a central irrigation system.

### SUMMARY OF THE INVENTION

A bubbler sprinkler head for an irrigation sprinkler system has a sprinkler head frame with a base connectable to a water supply and has a plurality of arms extending therefrom. A nozzle is attached to the sprinkler head frame for receiving water passing therethrough. A bubbler attachment is attached to the sprinkler head frame arms at a predetermined distance from the nozzle output. The bubbler attachment has a bubbler tube positioned axial alignment with the nozzle outlet for receiving water dispensed from the nozzle along with air drawn into the water steam from the space between the nozzle and said bubbler tube. A mixing chamber which may be a bowl having overflow walls is positioned below the bubbler tube outlet for receiving and mixing water and air from said bubbler tube outlet. The mixing chamber has overflow walls for dispensing the mixed water and air thereover, so that an irrigation system bubbler sprinkler head can generate bubbling water for irrigating an area adjacent thereto. The space between said nozzle and bubbler tube is open to atmosphere. The mixing chamber is generally bowl shaped and has walls for the overflow of bubbling water therefrom. The bubbler tube is formed of orifice plate having an opening therein with a short tube extending from the opening.

### BRIEF DESCRIPTION OF THE DRAWINGS

Other objects, features and advantages of the present invention will be apparent from the written description and the drawings in which:

FIG. 1 is a perspective view of a bubbler sprinkler head in accordance with the present invention;

FIG. 2 is a sectional view of the bubbler sprinkler head of FIG. 1;

FIG. 3 is an exploded sectional view of the bubbler sprinkler head of FIGS. 1 and 2;

FIG. 4 is a sectional view of the bubbler sprinkler head of FIGS. 1 through 3 illustrating the flow of water therethrough;

FIG. 5 is a top perspective view of the bubbler attachment of the bubbler sprinkler head of FIGS. 1 through 4; and

FIG. 6 is a bottom perspective view of the bubbler attachment of the bubbler sprinkler head of FIGS. 1 through 4.

### DESCRIPTION OF THE PREFERRED EMBODIMENT

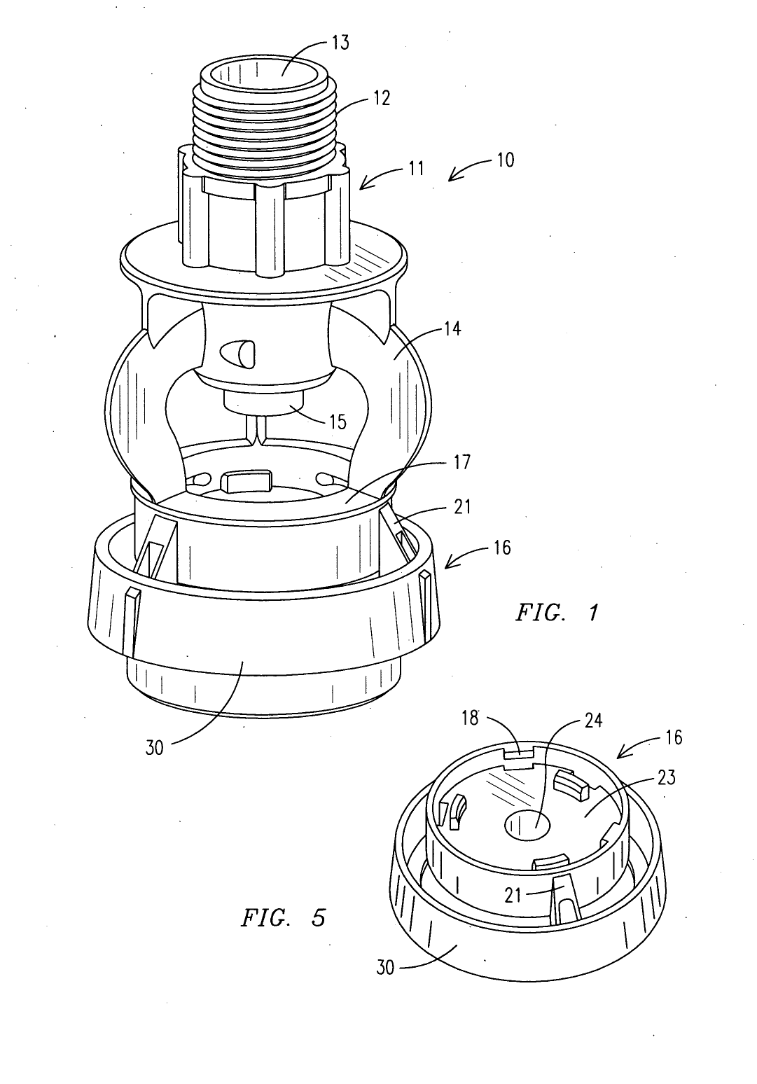

The present invention is for a water bubbler sprinkler head for use in an irrigation system. The irrigation water bubbler 10, as shown in the drawings, especially in FIGS. 1, 2, 3 and 4, has a sprinkler head frame 11 having a threaded connection 12 for attaching to a water line or hose. The frame has a water passageway 13 going therethrough and has a plurality of arms 14 extending therebelow. The frame 11 has a sprinkler nozzle 15 mounted therein at the end of the passageway 13 for directing water therefrom. The bubbler attachment 16 is attached to the base 17 of the arms 14. The water bubbler attachment 16, as shown in FIG. 5, has a plurality of attaching snaps 18 for attaching the bubbler attachment to the arms 14 base 17. The bubbler attachment 16 has a circular tray portion 20 having a plurality of support members 21 extending therefrom and attached to support the Circular wall 22.

The bubbler attachment 16 is formed with a plate 23 having an opening or orifice 24 therein, as seen in FIG. 5. A tube 25 extends from the plate 23, as seen in FIG. 6.

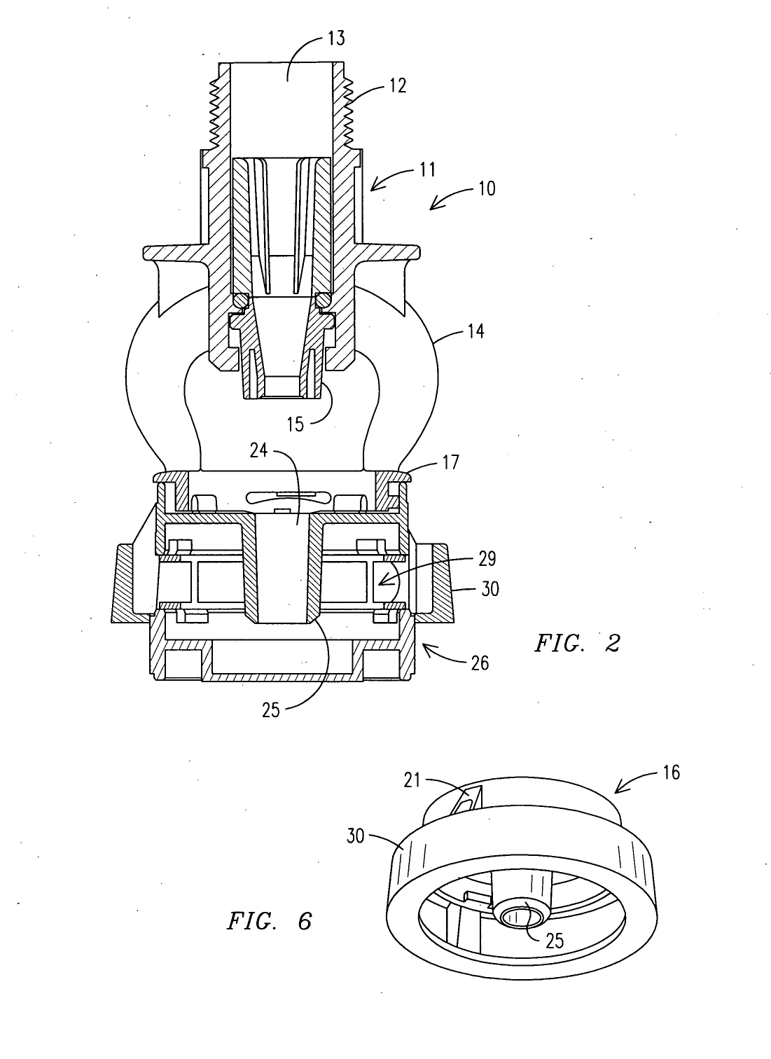

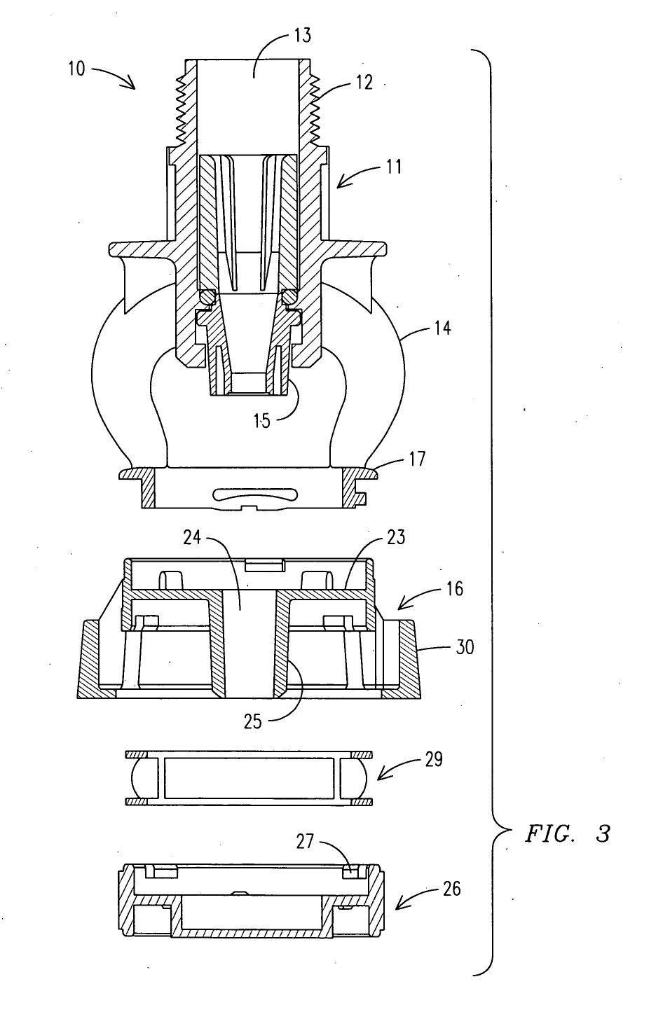

As more clearly seen in FIGS. 2, 3, and 4, a spacer member 29 is attached to the water bubbler attachment 16 and has a mixing chamber 26 attached to the bottom of the water bubbler attachment and beneath the spacer 29. The mixing chamber 26 has snap connectors 27 thereon for attaching the mixing chamber to the water bubbler attachment 16. In FIG. 3, it can be seen that the frame arms 14 base ring 17 has grooved areas 27 for attaching the water bubbler attachment 16.

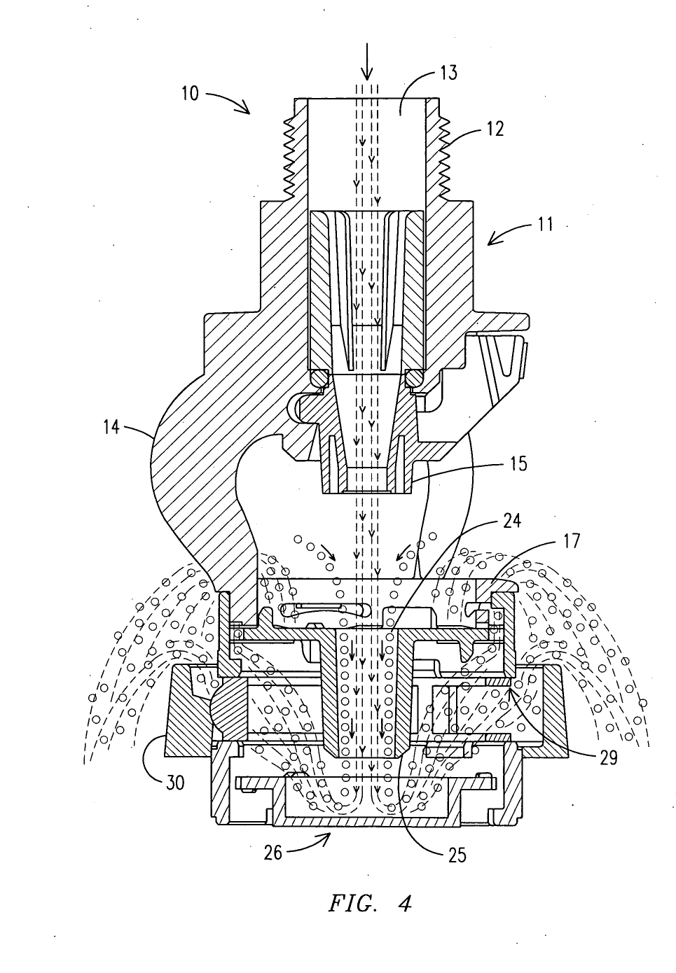

The operation of the water bubbler sprinkler head 10, as more clearly seen in FIG. 4, has the water entering the passageway 13 from a water main line drop hose. Water is fed through the nozzle 15, as shown by the arrows in FIG. 4, and passes through an opening space 28 that is open to the atmosphere. The water coming out of the nozzle 15 is directed toward the axially aligned orifice 24 and through the tube 25. It is directed through the tube 25 and into the mixing chamber 26. The water entering the orifice 24 and the tube 25 draws air into the water stream, as shown by the air bubbles of FIG. 4. Both water and air are directed into the mixing chamber 26 where it is thoroughly mixed to form water bubbles, or water with air bubbles therein, which are then forced up through the bottom of the spacer 29 and through the bubbler attachment and over the wall 30 of the bubbler attachment. The bubbling water spills over the wall 30 and out onto the ground below, such as into a furrow. Energy in the water is substantially reduced by the bubbling water overflowing the wall 30.

The bubbler attachment 16, plate 23 with the orifice 24 is shaped similar to the orifice plate but with the extending tube 25 extending from the opening 24. The water in the water bubbler attachment is passed from the nozzle 15 through an enlarged or atmospheric area 28 and into the orifice 24. It pulls air from the atmosphere thereinto which is thoroughly mixed and bubbled in the mixing chamber 26.

It should be clear at this point that an irrigation water bubbler has been provided which has proved effective in producing bubbling water which is fed indirectly from the mixing chamber over a wall where it falls gently onto the ground. However, the present invention should not be construed as limited to the forms shown which are to be considered illustrative rather than restrictive.

We claim:

1. A bubbler sprinkler head for an irrigation sprinkler system comprising:
a sprinkler head frame having a base connectable to water supply and having a passageway therethrough and having at least one arm extending therefrom;
a nozzle attached to said sprinkler head frame in line with said passageway for receiving water passing through said passageway, said nozzle having an outlet therefrom;
a bubbler attachment attached to said sprinkler head frame at least one arm and spaced a predetermined distance from said nozzle output, said bubbler attachment having a bubbler tube having an inlet and an outlet therefrom, said bubbler tube being in general axial alignment with said nozzle outlet for receiving water dispensed from said nozzle outlet along with air from the space between said nozzle outlet and said bubbler tube; and
a mixing chamber positioned below said bubbler tube outlet for receiving and mixing water and air from said bubbler tube outlet, said mixing chamber having overflow walls for dispensing said mixed water and air thereover;
whereby an irrigation system bubbler sprinkler head generates bubbling water for irrigating an area adjacent thereto.

2. The bubbler sprinkler head for an irrigation sprinkler system in accordance with claim 1 in which space between said nozzle and bubbler tube is open to the atmosphere.

3. The bubbler sprinkler head for an irrigation sprinkler system in accordance with claim 2 mixing in which said chamber has a generally bowl shape having walls for the overflow of bubbling water therefrom.

4. The bubbler sprinkler head for an irrigation sprinkler system in accordance with claim 3 in which said mixing chamber bowl has generally circular overflow walls.

5. The bubbler sprinkler head for an irrigation sprinkler system in accordance with claim 4 in which said bubbler tube forms an orifice plate for drawing atmospheric air into said bubbler tube.

6. The bubbler sprinkler head for an irrigation sprinkler system in accordance with claim 5 in which sprinkler head frame has a plurality of arms.

7. The bubbler sprinkler head for an irrigation sprinkler system in accordance with claim 6 in which said bubbler attachment has attachment means for attaching said bubbler attachment to said plurality of sprinkler frame arms.

8. The bubbler sprinkler head for an irrigation sprinkler system in accordance with claim 1 in which said bubbler attachment an orifice plate having an opening therein with a tube extending from the orifice plate opening.
